(19) United States
(12) Patent Application Publication
(10) Pub. No.: US 2024/0036381 A1
(43) Pub. Date: Feb. 1, 2024

(54) DISPLAY DEVICE

(71) Applicant: WUHAN CHINA STAR OPTOELECTRONICS TECHNOLOGY CO., LTD., Wuhan, Hubei (CN)

(72) Inventors: Wenlong Ye, Wuhan, Hubei (CN); Rui He, Wuhan, Hubei (CN); Wei Cheng, Wuhan, Hubei (CN); Xindong Mei, Wuhan, Hubei (CN)

(73) Assignee: WUHAN CHINA STAR OPTOELECTRONICS TECHNOLOGY CO., LTD., Wuhan, Hubei (CN)

(21) Appl. No.: 17/622,755

(22) PCT Filed: Dec. 13, 2021
(86) PCT No.: PCT/CN2021/137336

§ 371 Date: Dec. 24, 2021

(30) Foreign Application Priority Data
Dec. 3, 2021 (CN) 202111464370.7

(51) Int. Cl. G02F 1/1334; G02F 1/1335; G02F 1/1339; G02F 1/1347

(52) U.S. Cl. CPC G02F 1/13345; G02F 1/133531; G02F 1/13398; G02F 1/1347; G02F 1/133512

(57) ABSTRACT

A display device includes a first polarizer, a dimming liquid crystal panel, a second polarizer, and a display panel stacked in sequence. The dimming liquid crystal panel includes a first substrate, a second substrate, a first liquid crystal layer, and a plurality of support pillars. Each of the support pillars includes a first end and a second end that are opposite to each other. The first end and the second end respectively abut the first substrate and the second substrate.

### FIELD OF INVENTION

The present disclosure relates to a technical field of display, and particularly to a display device.

### BACKGROUND

With development of information technology, people pay more and more attention to personal information privacy, and anti-peep display devices came into being. When a polymer liquid crystal dimming panel is used in an anti-peep display device, a privacy mode and a sharing mode can be freely switched to meet needs of consumers on different occasions. The polymer liquid crystal dimming panel comprises a polymer network liquid crystal layer aligned in a specific direction. When squeezed by an external force, substrates of the polymer liquid crystal dimming panel will have a recoverable deformation, but the polymer network liquid crystal layer in the polymer liquid crystal dimming panel will have an irreversible deformation, which makes the polymer liquid crystal dimming panel invalid and unable to adjust a phase of a polarized light. Therefore, a privacy mode and a sharing mode cannot be freely switched.

### SUMMARY OF DISCLOSURE

The present disclosure provides a display device to solve a technical problem that a polymer network liquid crystal layer of a current polymer liquid crystal dimming panel is irreversibly deformed when being squeezed by an external force, which makes the polymer liquid crystal dimming panel invalid.

The present disclosure provides a display device to solve a technical problem that a polymer network liquid crystal layer of a current polymer liquid crystal dimming panel is irreversibly deformed when being squeezed by an external force, which makes the polymer liquid crystal dimming panel invalid.

In order to solve the above technical problem, the present disclosure provides the following technical solutions.

The present disclosure provides a display device comprising:
a display panel;
a liquid crystal dimming panel disposed on a side of the display panel and comprising:
   a first substrate and a second substrate that are disposed opposite to each other;
   a first liquid crystal layer disposed between the first substrate and the second substrate and comprising a plurality of polymer network liquid crystals; and
   a plurality of support pillars disposed between the first substrate and the second substrate, wherein each of the support pillars comprises a first end and a second end that are opposite to each other, one of the first end and the second end abuts the first substrate, and the other abuts the second substrate;
a first polarizer disposed on a side of the liquid crystal dimming panel away from the display panel; and
a second polarizer disposed between the display panel and the liquid crystal dimming panel, wherein a transmission axis of the first polarizer is parallel to a transmission axis of the second polarizer.

In an embodiment, an absolute value of a height difference between any two support pillars is 0 to 0.1 μm.

In an embodiment, a resilience ratio of the support pillars is 80% to 90%.

In an embodiment, an area ratio of the support pillars to the first substrate or the second substrate is 0.25% to 0.35%.

In an embodiment, the support pillars are doped with a nano-material.

In an embodiment, the support pillars are made of a photoresist material. The display panel comprises a plurality of sub-pixels disposed in an array. An orthographic projection of each of the support pillars on the display panel is located at a junction between two adjacent sub-pixels.

In an embodiment, the display panel further comprises a plurality of black matrices. Each of the black matrices is disposed between two adjacent sub-pixels. An orthographic projection of each of the support pillars on the black matrices is located within one black matrix.

In an embodiment, a length and/or width of an orthographic projection of the first end on the first substrate is 8-10 μm, and a length and/or width of an orthographic projection of the second end on the second substrate is 6-7 μm.

In an embodiment, the display panel further comprises:
a third substrate and a fourth substrate that are disposed opposite to each other;
a second liquid crystal layer disposed between the third substrate and the fourth substrate; and
a plurality of spacers disposed between the third substrate and the fourth substrate, wherein a rigidity of the support pillars is greater than a rigidity of the spacers.

The present disclosure further provides a display device comprising:
a display panel;
a liquid crystal dimming panel disposed on a side of the display panel and comprising:
   a first substrate and a second substrate that are disposed opposite to each other;
   a first liquid crystal layer disposed between the first substrate and the second substrate; and
   a plurality of support pillars disposed between the first substrate and the second substrate, wherein each of the support pillars comprises a first end and a second end that are opposite to each other, one of the first end and the second end abuts the first substrate, and the other abuts the second substrate;
a first polarizer disposed on a side of the liquid crystal dimming panel away from the display panel; and
a second polarizer disposed between the display panel and the liquid crystal dimming panel.

In an embodiment, an absolute value of a height difference between any two support pillars is 0 to 0.1 μm.

In an embodiment, a resilience ratio of the support pillars is 80% to 90%.

In an embodiment, an area ratio of the support pillars to the first substrate or the second substrate is 0.25% to 0.35%.

In an embodiment, the support pillars are doped with a nano-material.

In an embodiment, the support pillars are made of a photoresist material. The display panel comprises a plurality of sub-pixels disposed in an array. An orthographic projection of each of the support pillars on the display panel is located at a junction between two adjacent sub-pixels.

In an embodiment, the display panel further comprises a plurality of black matrices. Each of the black matrices is disposed between two adjacent sub-pixels. An orthographic projection of each of the support pillars on the black matrices is located within one black matrix.

In an embodiment, a length and/or width of an orthographic projection of the first end on the first substrate is 8-10 μm, and a length and/or width of an orthographic projection of the second end on the second substrate is 6-7 μm.

In an embodiment, the display panel further comprises:
a third substrate and a fourth substrate that are disposed opposite to each other;
a second liquid crystal layer disposed between the third substrate and the fourth substrate; and
a plurality of spacers disposed between the third substrate and the fourth substrate, wherein a rigidity of the support pillars is greater than a rigidity of the spacers.

In an embodiment, the first liquid crystal layer comprises a plurality of polymer network liquid crystals.

In an embodiment, a transmission axis of the first polarizer is parallel to a transmission axis of the second polarizer.

The present disclosure provides a display device comprising a display panel, a liquid crystal dimming panel disposed on a side of the display panel, a first polarizer disposed on a side of the liquid crystal dimming panel away from the display panel, and a second polarizer disposed between the display panel and the liquid crystal dimming panel. The liquid crystal dimming panel comprises a first substrate and a second substrate that are disposed opposite to each other, a first liquid crystal layer disposed between the first substrate and the second substrate, and a plurality of support pillars disposed between the first substrate and the second substrate. Each of the support pillars comprises a first end and a second end that are opposite to each other. One of the first end and the second end abuts the first substrate, and the other abuts the second substrate. By setting each of the support pillars in the liquid crystal dimming panel to abut the first substrate and the second substrate, a support strength for the liquid crystal dimming panel is enhanced. Therefore, when the display device is pressed by an external force, the support pillars can withstand the external force more stably, so that the first substrate and the second substrate are not deformed, thereby ensuring that a structure of the first liquid crystal layer of the liquid crystal dimming panel will not be damaged, and enhancing a stability of a structure of the liquid crystal dimming panel.

### BRIEF DESCRIPTION OF DRAWINGS

FIG. 1 is an exploded schematic structural diagram of a display device according to an embodiment of the present disclosure.

FIG. 2 is a schematic structural diagram of a liquid crystal dimming panel according to an embodiment of the present disclosure when it is not subjected to an external electric field.

FIG. 3 is a schematic structural diagram of the liquid crystal dimming panel according to the embodiment of the present disclosure under an external electric field.

FIG. 4 is a schematic structural diagram of the liquid crystal dimming panel according to the embodiment of the present disclosure under another external electric field.

FIG. 5 is a schematic structural diagram of the display device according to an embodiment of the present disclosure when it is not subjected to an external electric field.

FIG. 6 is a schematic structural diagram of the display device according to the embodiment of the present disclosure under an external electric field.

FIG. 7 is a schematic structural diagram of the display device according to the embodiment of the present disclosure under another external electric field.

FIG. 8 is a schematic structural diagram of a liquid crystal dimming panel in the prior art in a process of being squeezed by an external force.

FIG. 9 is a schematic structural diagram of the liquid crystal dimming panel according to the embodiment of the present disclosure in a process of being squeezed by an external force.

### DETAILED DESCRIPTION

Technical solutions in embodiments of the present disclosure will be clearly and completely described below in conjunction with accompanying drawings in the embodiments of the present disclosure. It is apparent that the described embodiments are merely a part of the embodiments of the present disclosure and not all embodiments. All other embodiments obtained by those skilled in the art based on the embodiments of the present disclosure without creative labor are within claimed scope of the present disclosure.

In the description of the present disclosure, it should be understood that terms “first” and “second” are only used for descriptive purposes, and cannot be understood as indicating or implying relative importance or implicitly indicating a number of technical features indicated. The features defined by “first” and “second” may explicitly or implicitly comprise one or more of the features. In the description of the present disclosure, a term “a plurality of” means “two or more” unless otherwise specifically limited. In the present disclosure, unless otherwise specifically specified or limited, a structure in which a first feature is “on” or “under” a second feature may comprise an embodiment in which the first feature directly contacts the second feature, and may also comprise an embodiment in which the first feature and the second feature are not in direct contact with each other, but are contacted via an additional feature formed therebetween. Furthermore, a structure in which a first feature is “on”, “above”, or “on top of” a second feature may comprise an embodiment in which the first feature is right or obliquely “on”, “above”, or “on top of” the second feature, or just means that a sea-level elevation of the first feature is greater than a sea-level elevation of the second feature.

The following description provides different embodiments or examples illustrating various structures of the present invention. In order to simplify the description of the present disclosure, only components and settings of specific examples are described below. They are only examples and are not intended to limit the present invention. Furthermore, reference numerals and/or letters may be repeated in different examples of the present disclosure. Such repetitions are for simplicity and clarity, which per se do not indicate relations among the discussed embodiments and/or settings. Furthermore, the present disclosure provides various examples of specific processes and materials, but those skilled in the art can be aware of application of other processes and/or use of other materials.

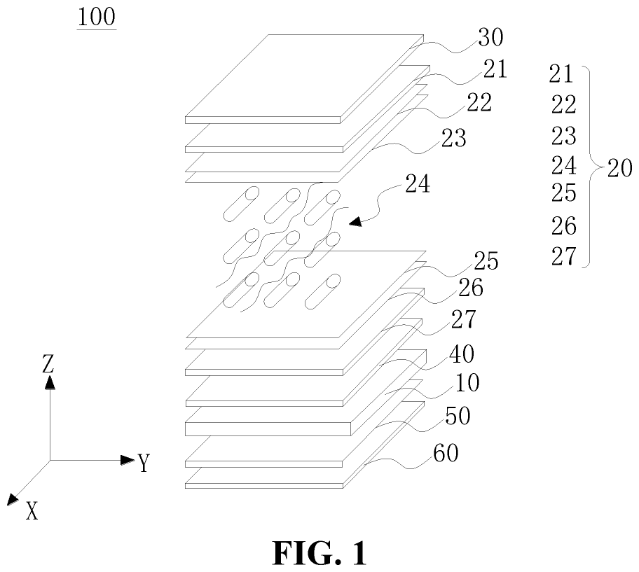

Please refer to FIG. 1, the present disclosure provides a display device 100 comprising a display panel 10 and a liquid crystal dimming panel 20. The display panel 10 is disposed on a side of the liquid crystal dimming panel 20. Specifically, the liquid crystal dimming panel 20 may be disposed on a light-emitting surface of the display panel 10, or may be disposed on a surface of the display panel 10 opposite to the light-emitting surface. In this embodiment, the liquid crystal dimming panel 20 is disposed on the light-emitting surface of the display panel 10 as an example for description.

The liquid crystal dimming panel 20 comprises a first substrate and a second substrate that are disposed opposite to each other, and a first liquid crystal layer 24 disposed between the first substrate and the second substrate

The display device 100 further comprises a first polarizer 30 disposed on a side of the liquid crystal dimming panel 20 away from the display panel 10, and a second polarizer 40 disposed between the display panel 10 and the liquid crystal dimming panel 20.

In this embodiment, the display panel 10 may be a liquid crystal display panel. In other embodiments, the display panel 10 may be an organic light-emitting diode (OLED) display panel. The display panel 10 comprises a third substrate and a fourth substrate that are disposed opposite to each other, and a second liquid crystal layer disposed between the third substrate and the fourth substrate.

When the display panel 10 is a liquid crystal display panel, in order to realize display function, the display device 100 further comprises a third polarizer 50 disposed on a side of the display panel 10 away from the liquid crystal dimming panel 20, and a backlight module 60 disposed on a side of the third polarizer 50 away from the display panel 10. A transmission axis of the third polarizer 50 is perpendicular to a transmission axis of the second polarizer 40. The backlight module 60 provides a backlight for the display panel 10. The backlight module 60 may be a direct-type backlight module or an edge-type backlight module, preferably a direct-type backlight module.

The display device 100 provided by the present disclosure can be switched between an anti-peep mode and a sharing mode. In the anti-peep mode, the display device 100 allows a light at a frontal viewing angle to pass through, and most of a light at a large viewing angle is absorbed. In the sharing mode, the lights at the frontal viewing angle and the large viewing angle can be emitted into a human eye.

Specifically, the first liquid crystal layer 24 in the liquid crystal dimming panel 20 comprises a plurality of polymer network liquid crystals (PNLCs), wherein liquid crystal molecules are distributed in a three-dimensional polymer network to form a continuous channel network. The polymer network liquid crystals can adjust a phase of a polarized light and switch between a transparent state and a fog state in a voltage-off state and a voltage-on state, thereby adjusting a viewing angle of the display panel 10. In the voltage-off state, the first liquid crystal layer 24 is in the transparent state and has a phase delay in a direction of a large viewing angle, thereby adjusting a phase of the polarized light at the large viewing angle emitted by the display panel 10, that is, a polarization state of the polarized light is changed. In the voltage-on state, the liquid crystal molecules are aligned under an electric field, and the polymer network liquid crystals scatter light without phase adjustment. Therefore, the polarized light of the display panel 10 will pass through the first liquid crystal layer 24, and its polarization state is not changed.

In the first liquid crystal layer 24, a pretilt angle may be formed by an alignment film or an electric field. The pretilt angle may be 1° to 89°. Preferably, the pretilt angle is 55° to 89°. Under the pretilt angle, the liquid crystal molecules have a better effect on phase adjustment at a large viewing angle of 45°, that is, a better effect of adjusting an anti-peep viewing angle.

Furthermore, the first substrate comprises a first base substrate 21, a first electrode 22 facing the first liquid crystal layer 24, and a first alignment layer 23 disposed on the first electrode 22 and facing the first liquid crystal layer 24. The second substrate comprises a second base substrate 27, a second electrode 26 facing the first liquid crystal layer 24, and a second alignment layer 25 disposed on the second electrode 26 and facing the first liquid crystal layer 24. The polymer network liquid crystals are aligned through the first alignment layer 23 and the second alignment layer 25.

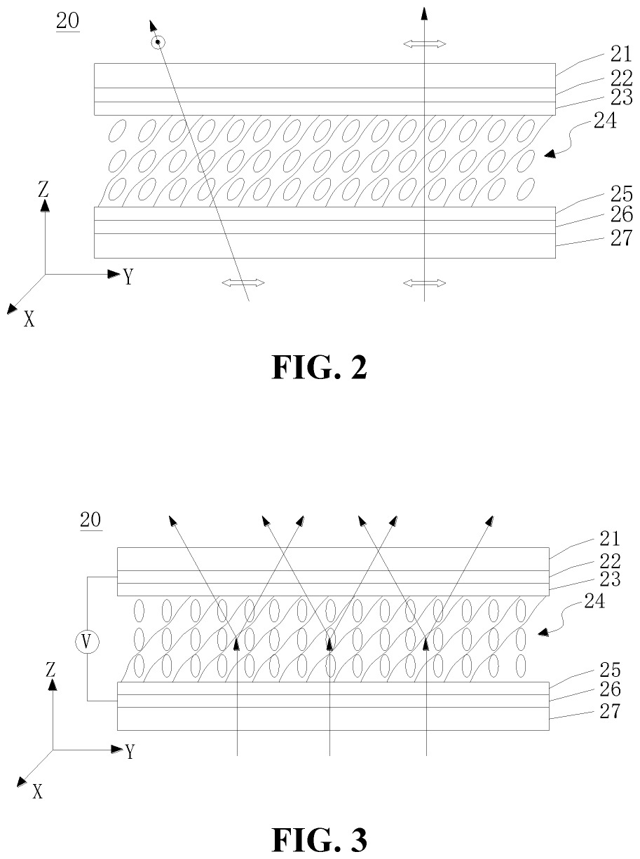

Please refer to FIG. 2, the polymer network liquid crystals in the first liquid crystal layer 24 are arranged obliquely without an external electric field. A tilt direction of the polymer network is parallel to a tilt direction (i.e. a pretilt direction) of the liquid crystal molecules. When a light passes through the polymer network liquid crystals, a refractive index of the polymer network is equal to a refractive index of the liquid crystal molecules, so there is no light scattering, and this state is the transparent state. In this state, in the direction of the large viewing angle (i.e. a direction at a specific angle to a Z-axis in an XZ plane), a linearly polarized light with a vibration direction of a Y-axis has a phase delay. That is, in the direction of the large viewing angle, the linearly polarized light vibrating in a direction of the Y-axis passes through long axes and short axes of the liquid crystal molecules to produce a phase difference, which changes a polarization state of the linearly polarized light. In a normal direction (i.e. a direction of the Z-axis) perpendicular to the display panel 10, the polymer network liquid crystals have no phase delay effect on the linearly polarized light. That is, the linearly polarized light in this direction only passes through the short axes of the liquid crystal molecules, so no phase difference occurs. The polarization state of the linearly polarized light in this direction is unchanged, so anti-peep display can be realized. The X, Y, and Z axes are perpendicular to each other. A plane formed by the X and Y axes is parallel to a plane where the display panel 10 is located.

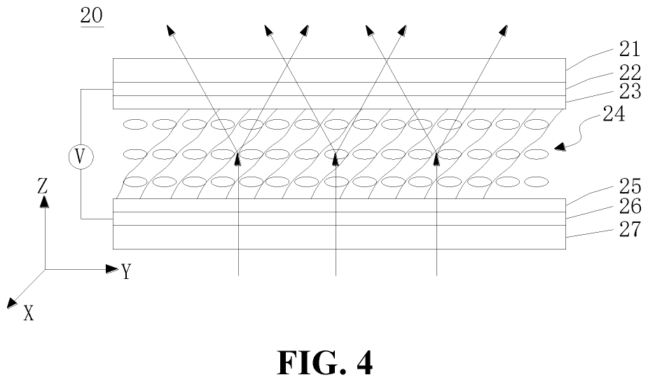

Please refer to FIG. 3, if the liquid crystal molecules in the first liquid crystal layer 24 are positive liquid crystal molecules, when an external electric field is applied, the liquid crystal molecules are aligned perpendicular to the first substrate and the second substrate, but the polymer network still maintains an initial tilted alignment state. At this time, when a light passes through the polymer network liquid crystals in this state, a refractive index difference occurs between the polymer network and the liquid crystal molecules. The refractive index of the polymer network is greater than the refractive index of the liquid crystal molecules, so light scattering occurs. Please refer to FIG. 4, if the liquid crystal molecules in the first liquid crystal layer 24 are negative liquid crystal molecules, when an external electric field is applied, the liquid crystal molecules are aligned parallel to the first substrate and the second substrate, but the polymer network still maintains the initial tilted alignment state. At this time, when a light passes through the polymer network liquid crystals in this state, a refractive index difference occurs between the polymer network and the liquid crystal molecules. The refractive index of the polymer network is less than the refractive index of the liquid crystal molecules, so light scattering also occurs. When an external electric field is applied to the first liquid crystal layer 24, the liquid crystal molecules are aligned under the external electric field, and light scattering occurs in the polymer network liquid crystals. At this time, because the polymer network liquid crystals do not produce a phase difference to the linearly polarized light, so it has no phase adjustment effect.

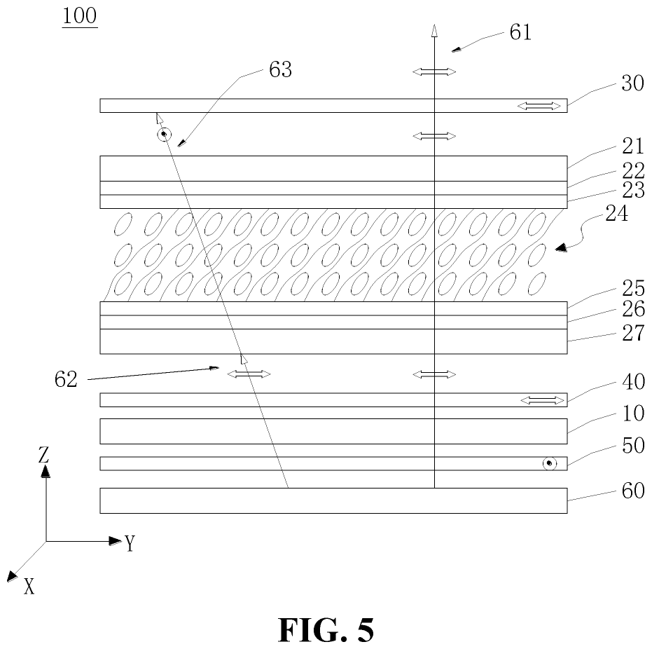

Please refer to FIG. 1 and FIG. 5, in an embodiment, a transmission axis of the first polarizer 30 is parallel to a transmission axis of the second polarizer 40. Orthographic projections of the long axes of the liquid crystal molecules on the first polarizer 30 are parallel to the transmission axis of the first polarizer 30. In absence of an external electric field (i.e. voltage-off), the liquid crystal molecules are arranged in the pretilt direction, and a light emitted from the display panel 10 enters the first liquid crystal layer 24 through the second polarizer 40. When a polarized light (i.e. a first light 61) emitted from the second polarizer 40 in the normal direction (i.e. the direction of the Z-axis) perpendicular to the display panel 10 passes through the polymer network liquid crystals, an angle between a vibration plane of the first light 61 and the liquid crystal molecules is zero degrees. The first light 61 has no phase delay, and its polarization state does not change. The transmission axis of the first polarizer 30 is parallel to the transmission axis of the second polarizer 40. Therefore, the polarized light can normally pass through the first polarizer 30 to the human eye. When a polarized light (i.e. a second light 62) emitted from the second polarizer 40 in a direction deviated from the normal direction (i.e. in a direction that is in an XY plane and is deviated from the direction of the Z-axis) passes through the polymer network liquid crystals, there is an angle between a vibration plane of the polarized light and the liquid crystal molecules. Therefore, under action of the liquid crystal molecules, the polarized light will produce a phase delay, causing a polarization state of the polarized light to change. The second light 62 is deflected into a third light 63, and the third light 63 cannot directly pass through the first polarizer 30.

When a polarization direction of the third light 63 is perpendicular to the direction the Y-axis, as shown in FIG. 5, the third light 63 will be completely blocked by the first polarizer 30. At this time, the user can only view a display image at a front view angle, while in other viewing angles, the display device 100 has no display image to prevent peeping. If the polarization direction of the third light 63 is at an acute angle to the direction of the Y-axis and the direction of the X-axis, the third light 63 will be divided into two parts in the direction of the Y-axis and the direction of the X-axis. The part of the third light 63 in the direction of the Y-axis can pass through the first polarizer 30. The part of the third light 63 in the direction of the Z-axis is blocked by the first polarizer 30. At this time, the user can view the display image normally at the front view angle, while at other viewing angles, display brightness is darker to prevent peeping.

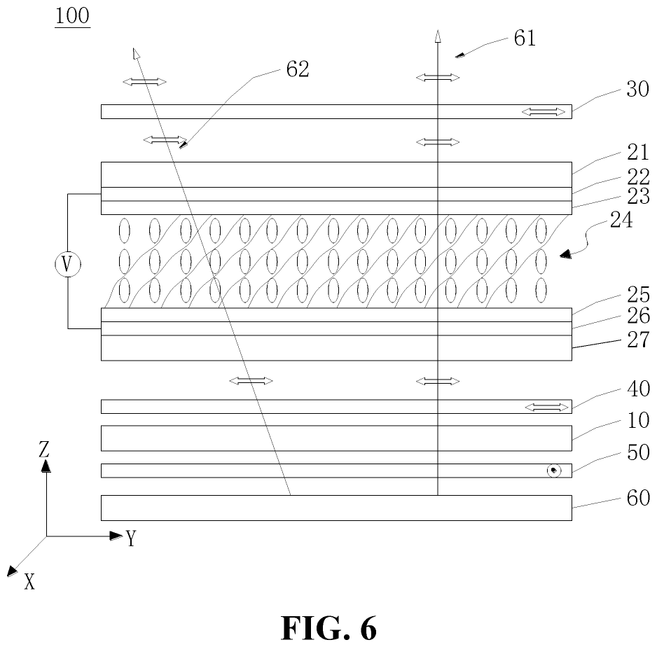

Please refer to FIG. 6, when a voltage is applied to the first electrode 22 and the second electrode 26, and the liquid crystal molecules are positive liquid crystal molecules, the liquid crystal molecules are aligned perpendicular to the first substrate and the second substrate under an electric field, while an alignment direction of the polymer network remains unchanged. In this state, the polymer network liquid crystals scatter light. A vibration plane of a polarized light emitted from the second polarizer 40 in the normal direction and a vibration plane of a polarized light emitted from the second polarizer 40 in the direction deviated from the normal direction are parallel to the liquid crystal molecules, and no phase delay occurs. Therefore, polarization states of the polarized lights emitted from the second polarizer 40 are not changed, and the polarized lights can be directly emitted from the first polarizer 30 to the human eye, thereby realizing the sharing mode (i.e. a wide viewing angle mode).

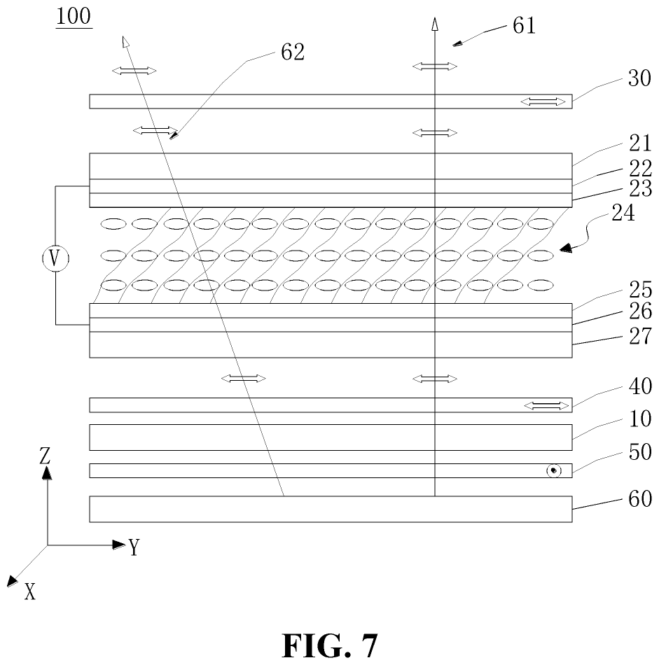

Please refer to FIG. 7, when the liquid crystal molecules are negative liquid crystal molecules, the liquid crystal molecules are aligned parallel to the first substrate and the second substrate under an electric field, while the alignment direction of the polymer network remains unchanged. In this state, the polymer network liquid crystals also scatter light. A vibration direction of the polarized light emitted from the second polarizer 40 in the normal direction and a vibration direction of the polarized light emitted from the second polarizer 40 in the direction deviated from the normal direction are parallel to the long axes of the liquid crystal molecules. And, no phase delay occurs after the polarized lights enter the polymer network liquid crystals. Therefore, polarization states of the first light 61 and the second light 62 are not changed, and the first light 61 and the second light 62 can be directly emitted from the first polarizer 30 to the human eye.

Furthermore, the display device 100 further comprises a phase compensation film. The phase compensation film is disposed between the liquid crystal dimming panel 20 and the backlight module 60, and is configured to compensate for large viewing angle light leakage when the display device 100 is in the sharing mode, so that a display viewing angle in the sharing mode is better. Specifically, the phase compensation film may be disposed between the liquid crystal dimming panel 20 and the second polarizer 40.

The phase compensation film may be a positive uniaxial C-type compensation film, a negative uniaxial C-type compensation film, or two A-type compensation films that are stacked and have optical axis directions orthogonal to each other.

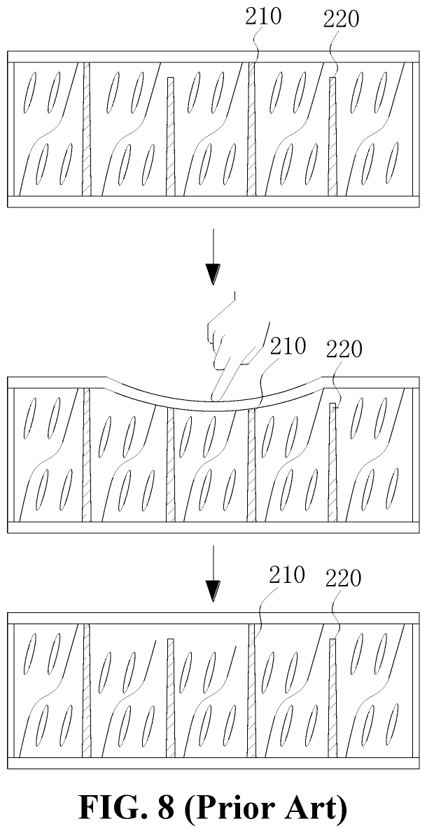

Please refer to FIG. 8. In the prior art, spacers are generally disposed in a liquid crystal dimming panel to support a certain cell thickness. The spacers comprise a plurality of main spacers 210 and a plurality of auxiliary spacers 220. A height of the main spacers 210 is higher than a height of the auxiliary spacers 220. Two opposite ends of each of the main spacers 210 are respectively in contact with an upper substrate and a lower substrate of the liquid crystal dimming panel. The main spacers 210 play a main supporting role and support a certain height. The auxiliary spacers 220 play an auxiliary supporting role when the liquid crystal dimming panel is squeezed by an external force, so as to reduce supporting pressure of the main spacers 210. When a display device is squeezed by an external force, the upper substrate, the lower substrate, the main spacers 210, and the auxiliary spacers 220 of the liquid crystal dimming panel are resiliently deformed, but polymer network liquid crystals in the liquid crystal dimming panel are irreversibly deformed. The polymer network liquid crystals in the liquid crystal dimming panel have certain requirements for an alignment direction, and need to be aligned in a specific direction. Therefore, after the polymer network liquid crystals are squeezed, an alignment direction of the polymer network liquid crystals are changed, which makes the liquid crystal dimming panel invalid. Therefore, the liquid crystal dimming panel cannot adjust a phase of a polarized light, and thus cannot realize free switching of an anti-peep mode and a sharing mode. In view of the aforementioned defects, the present disclosure improves a structure of a liquid crystal dimming panel to strengthen the structure of the liquid crystal dimming panel, so that a liquid crystal layer in the liquid crystal dimming panel is more stable.

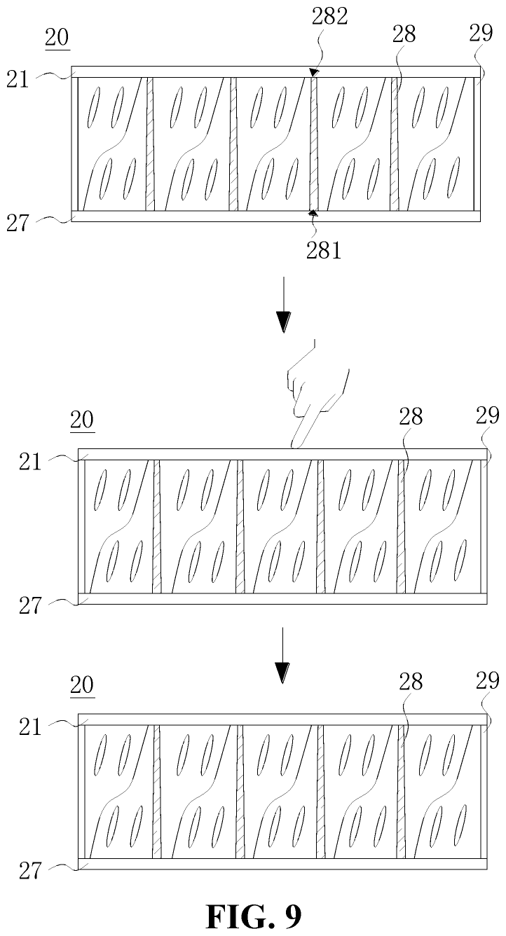

Please refer to FIG. 9, in order to simplify a structure of the liquid crystal dimming panel 20, FIG. 9 only shows the first base substrate 21 of the first substrate and the second base substrate 27 of the second substrate, but it does not mean that the first substrate only comprises the first base substrate 21, and the second substrate only comprises the second substrate 27. Specifically, in this embodiment, the liquid crystal dimming panel 20 comprises a plurality of support pillars 28 disposed between the first substrate and the second substrate. Each of the support pillars 28 comprises a first end 281 and a second end 282 that are opposite to each other. One of the first end 281 and the second end 282 abuts the first substrate, and the other abuts the second substrate. Compared with the prior art, all the support pillars 28 of this embodiment are in contact with the first substrate and the second substrate, which can improve a support strength for the liquid crystal dimming panel 20.

Specifically, please refer to FIG. 2, which does not show the support pillars 28. In this embodiment, one of the first end 281 and the second end 282 abuts the first alignment layer 23 of the first substrate, and the other abuts the second alignment layer 25 of the second substrate.

Furthermore, the first substrate 21 and the second substrate 27 are parallel to each other. A height error of the support pillars 28 can be controlled within 0.1 μm. That is, an absolute value of a height difference between any two support pillars 28 is 0 μm to 0.1 μm. The support pillars 28 whose height tends to be uniform can distribute a pressing force more uniformly and stably.

Moreover, a rigidity of the support pillars 28 may be increased, so that the support pillars 28 can bear a higher pressing force without being deformed, the liquid crystal dimming panel 20 is difficult to be deformed when subjected to external forces, and a structural stability of the liquid crystal dimming panel 20 is enhanced.

Specifically, it is found that when a resilience ratio of the support pillars 28 increases from 70%˜80% to 80%˜90%, the rigidity of the support pillars 28 can be effectively enhanced, and the structural stability of the liquid crystal dimming panel 20 is better maintained.

In this embodiment, the support pillars 28 are made of a photoresist material. The photoresist material may be a transparent photoresist material or a black photoresist material. In order to avoid the support pillars 28 from affecting pixels of the display panel 10, each of the support pillars 28 may be disposed corresponding to a junction between two adjacent sub-pixels of the display panel 10. That is, an orthographic projection of each of the support pillars 28 on the display panel 10 is located at a junction between two adjacent sub-pixels.

When the support pillars 28 are made of a black photoresist material, in order to prevent the support pillars 28 from blocking light, the orthographic projection of each of the support pillars 28 on the display panel 10 needs to be located at a junction between two adjacent sub-pixels. Furthermore, the display panel 10 further comprises a plurality of black matrices. Each of the black matrices is disposed between two adjacent sub-pixels, and the orthographic projection of each of the support pillars 28 on the black matrices is located within one black matrix, thereby preventing the support pillars 28 from affecting an aperture ratio of the pixels.

When the support pillars 28 are made of a transparent photoresist material, positions of the support pillars 28 may not be limited.

The photoresist material comprises a solvent, a dispersant, one or more reactive monomers, one or more polymers, and one or more photoinitiators. The solvent comprises one or more of 2-acetoxy-1-methoxypropane (PGMEA), 1-butanol (NBA), ethylene 3-ethoxypropionate (EEP), N,N′-methylene diacrylamide (MBA), cyclohexanone (CHN), and propylene glycol methyl ether (PGME). The reactive monomers comprise one or more of acrylic acid and styrene acrylic esters. The polymers comprise one or more of trimethylolpropane triacrylate (TMPTA), pentaerythritol triacrylate (PETA), dipentaerythritol hexaacrylate (DPHA), and diphenylphosphoryl azide (DPPA). The photoinitiators comprise one or more of acetophenone and amines.

A rigidity of the photoresist material may be improved by increasing contents of the reactive monomers containing rigid groups in the photoresist material. For example, contents of the reactive monomers containing aromatic groups such as benzene ring groups and styryl groups may be increased.

Furthermore, the support pillars 28 may be doped with a nano-material, so as to increase an overall rigidity of the support pillars 28. For example, the support pillars 28 may be doped with a carbon nano-material or the like.

Furthermore, a supporting effect of the support pillars 28 may be increased by changing contact areas of the support pillars 28 with the first substrate and the second substrate. Specifically, a length and/or width of an orthographic projection of the first end 281 of each of the support pillars 28 on the first substrate is 8-10 μm, and a length and/or width of an orthographic projection of the second end 282 on the second substrate is 6-7 μm. A shape of the orthographic projection of the first end 281 of each of the support pillars 28 on the first substrate and a shape of the orthographic projection of the second end 282 on the second substrate may be circles, ellipses, squares, rectangles, or trapezoids. A size and shape of a contact area between the first end 281 and the first substrate may be same as or different from a size and shape of a contact area between the second end 282 and the second substrate.

Specifically, when an orthographic projection of one end of each of the support pillars 28 on one substrate is a circle, the length and width refer to a diameter of the circle. When the orthographic projection of one end of each of the support pillars 28 on one substrate is an ellipse, the length refers to a long diameter of the ellipse, and the width refers to a short diameter of the ellipse. When the orthographic projection of one end of each of the support pillars 28 on one substrate is a trapezoid, the length refers to a length of longer one of two parallel sides of the trapezoid, and the width refers to a vertical distance between the two parallel sides of the trapezoid.

In this embodiment, an area of one end of each of the support pillars 28 is designed to have a maximum size, that is, the length and width of the first end 281 are 10 μm, and the length and width of the second end 282 are 7 μm.

On a premise of not affecting display effect, an area ratio of the support pillars 28 to the first substrate or the second substrate is 0.25% to 0.35%, which can improve an overall support strength of the liquid crystal dimming panel 20. Preferably, the area ratio is 0.3%. The area ratio of each of the support pillars 28 to the first substrate or the second substrate refers to a ratio of a sum of areas of orthographic projections of all the support pillars 28 on the first substrate (or the second substrate) to an area of the first substrate (or the second substrate).

When the display panel 10 is a liquid crystal panel, the display panel 10 comprises the third substrate and the fourth substrate that are disposed opposite to each other, the second liquid crystal layer disposed between the third substrate and the fourth substrate, and a plurality of spacers disposed between the third substrate and the fourth substrate. The support pillars 28 are disposed corresponding to the spacers. An orthographic projection of each of the spacers on the black matrices is located within one black matrix. The rigidity of the support pillars 28 is greater than a rigidity of the spacers. The rigidity mentioned in the present disclosure refers to a ability of an object to resist elastic deformation under an external force. The rigidity may be expressed by a force or moment required for per unit of deformation.

In this embodiment, the spacers of the display panel 10 comprise a plurality of main spacers and a plurality of auxiliary spacers. A height of the main spacers is higher than a height of the auxiliary spacers. Two opposite ends of each of the main spacers are respectively in contact with the third substrate and the fourth substrate. The main spacers play a main supporting role and support a certain cell thickness. When subjected to an external force, the auxiliary spacers play an auxiliary supporting role to reduce supporting pressure of the main spacers.

In this embodiment, the liquid crystal dimming panel 20 further comprises a sealant 29 disposed between the first substrate and the second substrate and forming a sealed cavity with the first substrate and the second substrate. A plurality of microspheres are dispersed in the sealant 29. By increasing an amount of the microspheres in the sealant 29, the support strength for the liquid crystal dimming panel 20 can also be further improved. The microspheres are made of silica.

In the above, the present disclosure provides a display device comprising a display panel 10, a liquid crystal dimming panel 20 disposed on a side of the display panel 10, a first polarizer 30 disposed on a side of the liquid crystal dimming panel 20 away from the display panel 10, and a second polarizer 40 disposed between the display panel 10 and the liquid crystal dimming panel 20. The liquid crystal dimming panel 20 comprises a first substrate and a second substrate that are disposed opposite to each other, a first liquid crystal layer 24 disposed between the first substrate and the second substrate, and a plurality of support pillars 28 disposed between the first substrate and the second substrate. Each of the support pillars 28 comprises a first end 281 and a second end 282 that are opposite to each other. One of the first end 281 and the second end 282 abuts the first substrate, and the other abuts the second substrate. By setting each of the support pillars 28 in the liquid crystal dimming panel 20 to abut the first substrate and the second substrate, a support strength for the liquid crystal dimming panel 20 is enhanced. Therefore, when the display device is pressed by an external force, the support pillars 28 can withstand the external force more stably, so that the first substrate and the second substrate are not deformed, thereby ensuring that a structure of the first liquid crystal layer 24 of the liquid crystal dimming panel will not be damaged, and enhancing a stability of a structure of the liquid crystal dimming panel 20.

In the above embodiments, the description of each embodiment has its own emphasis. For parts not detailed in one embodiment, reference may be made to the related descriptions in other embodiments.

The display device provided by the embodiments of the present disclosure is described in detail above. The present disclosure uses specific examples to describe principles and embodiments of the present application. The above description of the embodiments is only for helping to understand the technical solutions of the present disclosure and its core ideas. It should be understood by those skilled in the art that they can modify the technical solutions recited in the foregoing embodiments, or replace some of technical features in the foregoing embodiments with equivalents. These modifications or replacements do not cause essence of corresponding technical solutions to depart from the scope of the technical solutions of the embodiments of the present disclosure.

1. A display device, comprising:
a display panel;
a liquid crystal dimming panel disposed on a side of the display panel and comprising:
a first substrate and a second substrate that are disposed opposite to each other;
a first liquid crystal layer disposed between the first substrate and the second substrate and comprising a plurality of polymer network liquid crystals; and
a plurality of support pillars disposed between the first substrate and the second substrate, wherein each of the support pillars comprises a first end and a second end that are opposite to each other, one of the first end and the second end abuts the first substrate, and the other abuts the second substrate;
a first polarizer disposed on a side of the liquid crystal dimming panel away from the display panel; and
a second polarizer disposed between the display panel and the liquid crystal dimming panel, wherein a transmission axis of the first polarizer is parallel to a transmission axis of the second polarizer.

2. The display device according to claim 1, wherein an absolute value of a height difference between any two support pillars is 0 to 0.1 μm.

3. The display device according to claim 2, wherein a resilience ratio of the support pillars is 80% to 90%.

4. The display device according to claim 3, wherein an area ratio of the support pillars to the first substrate or the second substrate is 0.25% to 0.35%.

5. The display device according to claim 3, wherein the support pillars are doped with a nano-material.

6. The display device according to claim 3, wherein the support pillars are made of a photoresist material, the display panel comprises a plurality of sub-pixels disposed in an array, and an orthographic projection of each of the support pillars on the display panel is located at a junction between two adjacent sub-pixels.

7. The display device according to claim 6, wherein the display panel further comprises a plurality of black matrices, each of the black matrices is disposed between two adjacent sub-pixels, and an orthographic projection of each of the support pillars on the black matrices is located within one black matrix.

8. The display device according to claim 3, wherein a width of an orthographic projection of the first end on the first substrate is 8-10 μm, and a width of an orthographic projection of the second end on the second substrate is 6-7 μm.

9. The display device according to claim 1, wherein the display panel further comprises:
a third substrate and a fourth substrate that are disposed opposite to each other;
a second liquid crystal layer disposed between the third substrate and the fourth substrate; and
a plurality of spacers disposed between the third substrate and the fourth substrate, wherein a rigidity of the support pillars is greater than a rigidity of the spacers.

10. A display device, comprising:
a display panel;
a liquid crystal dimming panel disposed on a side of the display panel and comprising:
a first substrate and a second substrate that are disposed opposite to each other;
a first liquid crystal layer disposed between the first substrate and the second substrate; and
a plurality of support pillars disposed between the first substrate and the second substrate, wherein each of the support pillars comprises a first end and a second end that are opposite to each other, one of the first end and the second end abuts the first substrate, and the other abuts the second substrate;
a first polarizer disposed on a side of the liquid crystal dimming panel away from the display panel; and
a second polarizer disposed between the display panel and the liquid crystal dimming panel.

11. The display device according to claim 10, wherein an absolute value of a height difference between any two support pillars is 0 to 0.1 μm.

12. The display device according to claim 11, wherein a resilience ratio of the support pillars is 80% to 90%.

13. The display device according to claim 12, wherein an area ratio of the support pillars to the first substrate or the second substrate is 0.25% to 0.35%.

14. The display device according to claim 12, wherein the support pillars are doped with a nano-material.

15. The display device according to claim 12, wherein the support pillars are made of a photoresist material, the display panel comprises a plurality of sub-pixels disposed in an array, and an orthographic projection of each of the support pillars on the display panel is located at a junction between two adjacent sub-pixels.

16. The display device according to claim 15, wherein the display panel further comprises a plurality of black matrices, each of the black matrices is disposed between two adjacent sub-pixels, and an orthographic projection of each of the support pillars on the black matrices is located within one black matrix.

17. The display device according to claim 12, wherein a width of an orthographic projection of the first end on the first substrate is 8-10 μm, and a width of an orthographic projection of the second end on the second substrate is 6-7 μm.

18. The display device according to claim 10, wherein the display panel further comprises:
a third substrate and a fourth substrate that are disposed opposite to each other;
a second liquid crystal layer disposed between the third substrate and the fourth substrate; and
a plurality of spacers disposed between the third substrate and the fourth substrate, wherein a rigidity of the support pillars is greater than a rigidity of the spacers.

19. The display device according to claim 10, wherein the first liquid crystal layer comprises a plurality of polymer network liquid crystals.

20. The display device according to claim 10, wherein a transmission axis of the first polarizer is parallel to a transmission axis of the second polarizer.
